(19) United States
(12) Patent Application Publication
(10) Pub. No.: US 2020/0058023 A1
(43) Pub. Date: Feb. 20, 2020

(54) Decentralized Data Marketplace

(71) Applicant: Grandata Inc., San Francisco, CA (US)

(72) Inventors: Matias Travizano, San Francisco, CA (US); Martin Minnoni, Buenos Aires (AR); Daniel Fernandez, Buenos Aires (AR); Ariel Futoransky, Buenos Aires (AR); Gustavo Ezequiel Ajzenman, Oakland, CA (US); Carlos Sarraute, Buenos Aires (AR)

(73) Assignee: Grandata Inc.

(21) Appl. No.: 16/539,863

(22) Filed: Aug. 13, 2019

Related U.S. Application Data
(60) Provisional application No. 62/718,849, filed on Aug. 14, 2018.

(51) Int. Cl. G06Q 20/38; G06F 16/23; G06F 16/955; G06Q 20/40

(52) U.S. Cl. CPC G06Q 20/3829; G06F 16/2365; G06Q 2220/00; G06Q 20/401; G06F 16/9566

(57) ABSTRACT

A blockchain-based, decentralized data marketplace is described. The marketplace allows data sellers to sell their data to data buyers in exchange for payments in tokens. The marketplace allows for securely and anonymously selling data in a trusted environment that is also fair to all participants and provides data sellers with the ability to control and monetize their own data (e.g., personal data). A notary with access to “ground truth” data can validate data that is being offered in the marketplace to ensure that it is not falsified or fabricated before it is purchased by a data buyer. The marketplace implements blockchain-based smart contracts that work together, and with cryptographic protocols, to achieve an efficient, decentralized data marketplace where data sellers and data buyers transact directly with one another while remaining anonymous, if desired.

### CROSS REFERENCE TO RELATED APPLICATION

This application claims priority to commonly assigned, co-pending U.S. Provisional Patent Application Ser. No. 62/718,849, filed Aug. 14, 2018, entitled “WIBSON: A DECENTRALIZED MARKETPLACE EMPOWERING INDIVIDUALS TO SAFELY MONETIZE THEIR PERSONAL DATA,” which is fully incorporated herein by reference.

### BACKGROUND

The Internet is a fundamentally decentralized system that links billions of interconnected devices to improve communication, access to information, and economic possibilities for billions of people across the globe. Yet despite its distributed nature, giant data-driven companies have cleverly used the underlying technical protocols to build layers of proprietary applications that capture and control massive amounts of personal data. In today's information-driven economy, data equals money.

Although governmental agencies and consumer rights organizations are trying to maintain an appropriate balance of transparency, use, and access when it comes to personal data, the broken data ecosystem that has evolved since the Internet age takes the control over personal data away from its rightful owner—the individual. In today's data ecosystem, the individual user lacks control over his/her personal data in terms of how the data is used, by whom, and for what purpose. This means that large data-driven companies remain in control of the personal data they collect, enabling them to extract all of the value generated from the data. This data ecosystem also exposes mass amounts of personal data to theft from hackers who may breach the security protocols of the companies that hold the personal data of users.

The disclosure made herein is presented with respect to these and other considerations.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1A is a diagram illustrating a blockchain-based, decentralized data marketplace and a protocol for exchanging data within the marketplace.

FIG. 1B is a diagram illustrating the marketplace of FIG. 1A with the addition of a delegate as a marketplace participant.

FIG. 2 illustrates example user interfaces of a client application that can be displayed on a computing device of a data seller, the data seller being one example marketplace participant.

FIGS. 3A, 3B, and 3C collectively illustrate a flowchart of an example process for exchanging data via a blockchain-based, decentralized data marketplace. FIG. 3A illustrates example operations performed by a buyer device during the data exchange process, FIG. 3B illustrates example operations performed by a seller device during the data exchange process, and FIG. 3C illustrates example operations performed by a notary device (and possibly some operations performed by a delegate device) during the data exchange process.

FIG. 4 is a block diagram of an example architecture of a computing device(s) configured to implement the techniques described herein.

### DETAILED DESCRIPTION

Described herein are, among other things, techniques and systems for implementing a blockchain-based, decentralized data marketplace that allows data sellers to sell their data to data buyers in exchange for payments in tokens. The marketplace described herein allows for securely and anonymously selling data in a trusted environment that is also fair to all participants and provides data sellers with the ability to maintain ownership and control of their own data (e.g., personal data) in order to monetize it, if desired. The marketplace participants include a data seller, a data buyer, a notary, and, in some cases, a delegate. Data sellers are entities (e.g., individuals) who own data and have the right to sell that data within the decentralized data marketplace in exchange for a payment in tokens. In some embodiments, the data owned by the data sellers comprises personal data of the data sellers (e.g., their own financial transaction data, social network data, browsing history data, geolocation data, phone call data, biometric data—e.g., face data, fingerprint data, eye-print data, voice-print data, etc.). Data buyers are entities (e.g., companies or individuals) who can purchase data that is offered in the marketplace by data sellers. An example of a data buyer is a company who would like to train its own machine learning models using data purchased via the decentralized data marketplace. For instance, a company may be interested in acquiring financial transaction data of a particular demographic population to train a machine learning model to perform a classification task based on new, unknown financial transaction data.

The role of the notary is to validate participants of the marketplace and/or the data that is being offered in the marketplace in terms of ensuring its validity (e.g., ensuring that the participants and/or data is not falsified or fabricated) before the data is purchased by a data buyer. One characteristic of the notary is that the notary has access to “ground truth” data that is usable to validate participants and/or the data that is being offered in the decentralized marketplace for accuracy. In other words, the notary can be any entity (e.g., a bank, a social network service provider, a mobile application vendor or web-browser vendor, a telecommunications company, etc.) with its own previously-collected data pertaining to individuals (users of its products or services). This puts the notary in a good position to validate data that is being offered in the marketplace to data buyers. Imagine a data seller who wants to sell his/her financial transaction data. In this scenario, the seller's bank is an ideal notary because the bank already has the financial transaction data and can validate the data that is being offered in the marketplace before it is purchased by a data buyer. The notary can also arbitrate if a conflict or disagreement arises between a data seller and a data buyer.

A delegate is an entity that participates in the decentralized marketplace by sending blockchain-based transactions on behalf of another participant in exchange for a fee in tokens). For example, if certain participants, such as notaries and/or sellers, do not possess any blockchain tokens (e.g., Ether) that are usable to invoke or call a smart contract method, the delegate can assist those marketplace participants by submitting blockchain-based transactions on their behalf.

The decentralized nature of the data marketplace described herein means that any participant who qualifies can enter the marketplace as a data seller, a data buyer, a notary, or, in some cases, a delegate. Decentralization also means that there is no central authority to regulate the participants of the market, and there is no central data repository; the data sellers are the owners of, and remain in full control over, their data. Moreover, there is no central funds repository in the data marketplace, thereby providing a “trustless” system where actors do not have to entrust their funds to a third party.

The techniques and systems described herein utilize blockchain-based smart contracts (sometimes shortened herein to “smart contract,” or “contract”). A first smart contract (also referred to herein as “Data Exchange”) is a blockchain mechanism that is used by data buyers to create data orders for requested data that the buyers are interested in buying. Data Exchange (the first smart contract) maintains references to those data orders so that the data orders are accessible to other market participants, such as data sellers and notaries. Data sellers and notaries can react to the data orders by agreeing to sell the requested data and agreeing to validate the requested data, respectively. Thus, Data Exchange (the first smart contract) provides a secure mechanism for exchanging data in the decentralized marketplace. A second smart contract (also referred to herein as “Batch Payments”) provides a payment protocol that enables the direct transfer of payments between participants (e.g., data buyers, data sellers, notaries, and, in some cases, delegates) of the marketplace. One challenge for the viability and scaling of blockchain networks is managing the costs of smart contract transactions. Batch Payments (the second smart contract) addresses this challenge by batching multiple payments (which are each associated with a smart contract transaction) together into a single batch of payments, and performing a single smart contract transaction to pay potentially multiple participants, which helps to reduce transaction costs associated with operations in the blockchain.

By leveraging trust mechanisms arising from blockchain, the smart contracts described herein (e.g., Data Exchange and Batch Payments) work together, and with cryptographic protocols, to achieve an efficient, decentralized marketplace that allows data sellers and data buyers to transact with each other directly, without compromising their ability to remain anonymous in the marketplace. For example, the identity of the data seller is not revealed to the data buyer without the consent of the data seller. Meanwhile, notaries have public identities and an off-chain, public reputation. The blockchain-based smart contracts disclosed herein, when used with cryptographic protocols, allow for atomic transactions to occur in the marketplace. “Atomicity”, in this context, means that, once data is revealed to the data buyer, the data seller receives a payment for the data, and the notary also receives a payment for validating the data—none of the events occur independently without the others also occurring. The payments that the seller and notary (and sometimes the delegate) receive also act as financial incentives to participate in the data marketplace.

With respect to a data buyer, an example process implemented by a computing device of the data buyer includes executing a first instruction to call a first method of a first blockchain-based smart contract (e.g., Data Exchange) to create a data order for requested data. After creating the data order, the computing device may access a public address of the data buyer so that the data buyer can see the data sellers who have selected the data order and have agreed to sell their data to the data buyer. If the data buyer selects an identifier(s) of a data seller(s), the computing device receives an indication of this selected identifier(s), and the computing device may receive (e.g., download) the encrypted data of the associated data seller(s) via the buyer's public address. The computing device may also send the identifier(s) of the data seller(s) and a hash of the seller's encrypted data to a public address of a notary. After the notary validates the encrypted data of the seller(s), the computing device of the data buyer receives, via the public address of the data buyer, an encrypted cryptographic key(s) (the cryptographic key(s) having been used by the seller(s) to encrypt his/her data) along with an indication that the seller's data was validated by the notary (i.e., notarization results). The buyer device may also receive a lock from the notary. With validated seller data in hand, the computing device of the data buyer may execute second instructions to call a second method of a second blockchain-based smart contract (e.g., Batch Payments), the second method specifying the identifier(s) of the data seller(s) and an identifier of the notary, which authorizes respective payments to be made to respective accounts of the data seller(s) and the notary. Once the notary reveals a master key via the second blockchain-based smart contract, the computing device of the data buyer can decrypt the encrypted cryptographic key of the data seller using the master key, and may thereafter use the cryptographic key to decrypt the seller's encrypted data to obtain the purchased data of the data seller in unencrypted form.

With respect to a data seller, an example process implemented by a computing device of the data seller includes causing a set of data orders to be displayed on the computing device, the set of data orders having been created by a corresponding set of data buyers using a first blockchain-based smart contract (e.g., Data Exchange). If the data seller selects a data order, the computing device encrypts the data of the data seller using a cryptographic key, determines a public address of the data buyer based on the selected data order, and sends the seller's encrypted data to the public address of the data buyer. The computing device also sends the seller's encrypted data and the cryptographic key to a public address of a notary so that the notary can validate the seller's data for the data buyer as a validation service. If the seller's data was validated by the notary, and the notary reveals a master key via a second blockchain-based smart contract (e.g., Batch Payments), a payment for the seller's data is transferred to the seller's account. Thereafter, the computing device of the data seller can receive a batch of payments that includes the payment for the seller's data purchased by the data buyer. This can be done by executing instructions to call a method of the second blockchain-based smart contract (e.g., Batch Payments).

With respect to a notary, an example process implemented by a computing device of the notary includes receiving an indication that the notary has agreed to validate requested data for a data order that was created by a data buyer using a first blockchain-based smart contract (e.g., Data Exchange), and accessing a public address of the notary to receive encrypted data and a cryptographic key from a data seller who has selected the data order. The computing device of the notary may also receive a first hash value from the data buyer and an identifier of the data seller selected by the data buyer. If the notary determines that a second hash value generated based on the seller's encrypted data matches the first hash value, the notary can deduce that it has the same encrypted seller data that is in the data buyer's possession. The computing device of the notary can further decrypt the seller's encrypted data and compare the seller's data to previously-collected data in its possession (i.e., ground truth data) to determine whether the seller's data is valid (e.g., not fabricated, falsified, etc.). If the notary validates the seller's data, the computing device of the notary encrypts the seller's cryptographic key using a master key, and sends the encrypted key and the notarization result(s) to a public address of the data buyer so that the data buyer can decrypt the seller's data once the master key is revealed. The computing device of the notary then reveals the master key by executing instructions to call a method of a second blockchain-based smart contract (e.g., Batch Payments), which triggers respective payments to the data seller and the notary for selling and validating, respectively, the data purchased by the data buyer. Thereafter, the computing device of the notary can receive a batch of payments that includes the payment for the notaries services in validating the data purchased by the data buyer. This can be done by executing instructions to call a method of the second blockchain-based smart contract (e.g., Batch Payments).

Also disclosed herein are systems comprising one or more processors and one or more memories, as well as non-transitory computer-readable media storing computer-executable instructions that, when executed, by one or more processors perform various acts and/or processes disclosed herein.

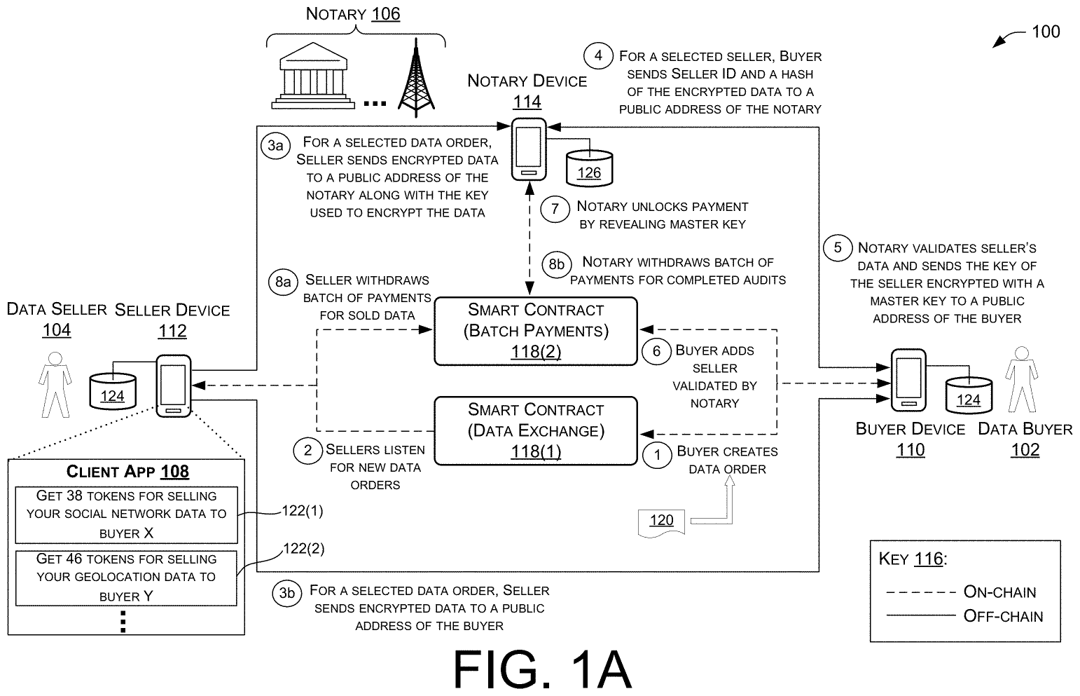

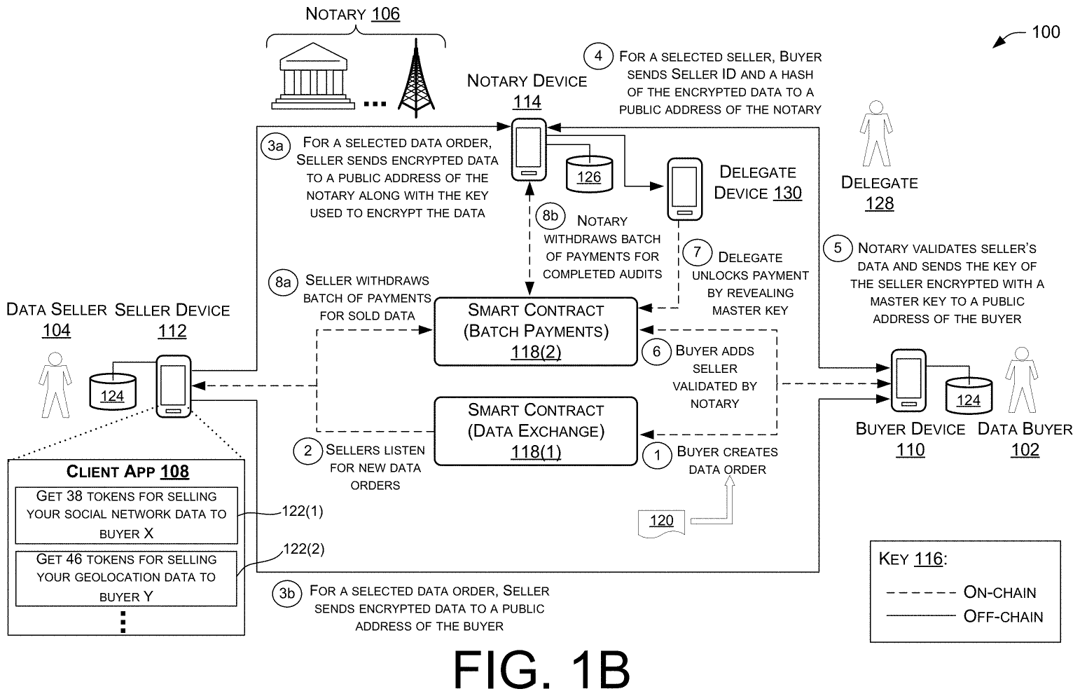

FIG. 1A is a diagram illustrating a blockchain-based, decentralized data marketplace 100 (sometimes shortened herein to “marketplace 100,” “decentralized marketplace 100,” “data marketplace 100,” or “decentralized data marketplace 100”). It is to be appreciated that the elements shown in FIG. 1A are merely illustrative and are referenced for explanatory purposes. Furthermore, although example devices and systems to implement the disclosed techniques are described in more detail below, it is to be appreciated that the techniques described herein are not limiting.

FIG. 1A illustrates example participants of the decentralized marketplace 100, which include, without limitation, a data buyer 102 (sometimes shortened to “buyer 102”), a data seller 104 (sometimes shortened to “seller 104”), and a notary 106. Each participant may be associated with a corresponding computing device that is usable to access the data marketplace 100 by virtue of a client application 108 (sometimes referred to as a “client app 108”) executing thereon. For example, the buyer 102 is associated with a buyer device 110, the seller 104 is associated with a seller device 112, and the notary 106 is associated with a notary device 114, and each of those devices 110/112/114 may have downloaded a respective version of a client app 108 that transforms the computing devices into devices that are able to access the marketplace 100. In some embodiments, the client app 108 may execute on a server computer, and the devices 110/112/114 may access the client app 108 as a “thin client.”

These computing devices 110/112/114 of FIG. 1A (and the computing device 130 of FIG. 1B) may individually be implemented as any suitable type of computing device, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), an in-vehicle (e.g., in-car) computer, a television (smart television), a set-top-box (STB), a game console, a desktop computer, a server, a datacenter hosted server, and the like. It is also to be appreciated that the data marketplace 100 may be accessed by any number of participants (e.g., buyers 102, sellers 104, notaries 106, and, in some cases, delegates 128 (See FIG. 1B)) using their respective computing devices 110/112/114/130, and that the examples of FIG. 1A—which illustrates a single buyer 102, a single seller 104, and a single notary 106—and FIG. 1B—which illustrates a single delegate 128—are merely illustrative for purposes of explaining the techniques and systems described herein. In practice, there is theoretically no limit to the number of participants who may participate in the marketplace 100. As such, the marketplace 100 may support billions of participants across the globe.

The decentralized data marketplace 100 may be implemented as any suitable platform for the trade of data, and it may provide: (i) the infrastructure for a market whereby parties engage in the exchange of data (e.g., sellers 104 offering their data in exchange for money from buyers 102); (ii) mechanisms for any tradeable data item to be evaluated and valued; (iii) incentives for participants to be honest, and an enforcement system to take actions if a dishonest behavior is chosen; and (iv) incentives for participants to ensure that data is trustworthy, and to provide quality data with an enforcement system to ensure that data is valid. The data marketplace 100 may be “decentralized” in the sense that there is no central authority which regulates the participants of the marketplace 100, there is no central data repository (users who generate the data are the owners of the data, and they keep their data in storage media accessible to their own devices to maintain full control of their data assets), and there is no central funds repository, thereby providing a trustless system where actors do not have to entrust their funds to a third party. The data marketplace 100 may also be a privacy-preserving marketplace 100 by allowing users to sell private data, while providing them with privacy guarantees including, without limitation, (i) participants' anonymity: the identity of the sellers 104 and buyers 102 are not revealed without their consent, and, in particular, the identity of the data seller 104 is not revealed to the data buyer 102 without the consent of the data seller 104; (ii) transparency over data usage: the data seller 104 has visibility as to how his/her data is used by the data buyer 102; and (iii) control over data usage: the data seller 104 can modify the rights over his/her data at any time.

A data buyer 102 may be any entity (e.g., a company or individual) who wants to purchase data that is offered in the marketplace 100 by data sellers 104. A set of buyers 102 may be denoted herein as B={B₁, . . . Bₙ}. An example of a data buyer 102 is a company or an organization (e.g., technology company, academic or research organizations, etc.) who would like to train machine learning algorithms and/or models. Other examples of data buyers 102 include advertisers and marketers. An example benefit to data buyers 102 of the decentralized data marketplace 100 described herein is that, because a notary 106 is leveraged in the protocol for exchanging data in order to ensure the validity of data before it is purchased, a data buyer 102 can ensure that it is purchasing high-quality, verified data. Buyers 102 can also rest assured that the data they are purchasing was sold to them with explicit consent of the data seller 104, as opposed to purchasing the same data from a technology company that captured the data from an individual. In other words, data buyers 102 receive data from willing and actively participating individuals (data sellers 104), with the benefit of knowing that the data being purchased is accurate and current due to the notary's 106 involvement in the data exchange protocol.

A data seller 104 may be any entity (e.g., an individual) who owns data and has rights to sell that data via the marketplace 100. For example, the data seller 104 may be an individual person who wants to sell his/her personal data (e.g., without limitation, his/her own financial transaction data, social network data, browsing history data, geolocation data, phone call data, biometric data, genetic data, device information, fitness application data, financial and lifestyle application data, other wireless device or desktop application data, and/or any other data generated by the data seller). A set of sellers 104 may be denoted herein as S={S₁, . . . Sₘ}.

A notary 106 may be any entity (e.g., a company) with access to “ground truth” data that is usable to validate the data that is being offered in the decentralized marketplace 100 for accuracy. In other words, the notary 106 can be any entity (e.g., without limitation, a bank or financial company, a social network service provider, a mobile application vendor, a telecommunications company, an Internet service provider, a healthcare company, an e-commerce company, an online or brick-and-mortar retailer, and/or any other business, corporation or organization that possesses ground-truth data assets) with its own previously-collected data (e.g., files) pertaining to data sellers 104, which puts the notary in a good position to validate data that is being offered in the marketplace 100 to data buyers 102. A set of notaries 106 may be denoted herein as N={N₁, . . . Nₚ}. Notaries 106 have public identities and an “off-chain” reputation (“off-chain” meaning, not on the blockchain, e.g., public), which allows for buyers 102 and sellers 104 to evaluate notaries 106 for quality of service. The role of the notary 106 is to act as a verification system to verify participants' information, if required, verify data quality and trustworthiness, if required, and/or to arbitrate if a conflict or disagreement arises between a data seller 104 and a data buyer 102.

The marketplace 100 described herein is a blockchain-based marketplace 100. A “blockchain” is an open, public, distributed ledger that can record transactions between several parties efficiently and in a verifiable and permanent way. An example of a blockchain-based distributed computing platform that can be utilized with the decentralized marketplace 100 described herein is Ethereum (sometimes referred to as the “Ethereum network,” or the “Ethereum blockchain”), which supports smart contract (scripting) functionality. A “smart contract 118”, in this context, is application logic that can be expressed using the operations defined in the Ethereum Virtual Machine (EVM). EVM operations codes (opcodes) are low-level machine language (EVM byte code). Developers can write smart contracts 118 in high-level programming language (e.g., Solidity) that compile down to low-level EVM opcodes. A smart contract 118 can be deployed to the blockchain (e.g. Ethereum blockchain) and given a public address by sending the byte code of the smart contract 118 as a transaction to the blockchain network, and this transaction is then “mined,” whereby transactions are added to a large distributed, public ledger of existing transactions, known as the blockchain.

The marketplace 100 protocol that is used to effectuate the exchange of data and payments for that data within the marketplace 100 is executed partly “on-chain” and partly “off-chain”. On-chain operations (denoted by the dashed lines in FIGS. 1A and 1B, as indicated in the key 116) are performed with respect to smart contracts 118 of the blockchain network. For example, a computing device executing instructions to call a method of a smart contract 118 is an example of an on-chain operation. Meanwhile, off-chain operations (denoted by the solid lines in FIGS. 1A and 1B, as indicated in the key 116) are performed independent of a smart contract 118 (e.g., a message sent by one market participants to a public addresses of another market participant is an example of an off-chain operation).

FIG. 1A depicts two example blockchain-based smart contracts 118 (sometimes shortened herein to “smart contracts 118,” or “contracts 118”). These smart contracts 118 can be deployed to the blockchain in order to implement aspects of the marketplace 100 described herein. Participants, such as the data buyer 102, the data seller 104, and the notary 106, may register with these smart contracts 118 so that the contracts 118 can be utilized by the participants. In response to registering with a smart contract 118, a participant may receive an identifier associated with that smart contract 118.

A first smart contract 118(1) of the marketplace 100 is also referred to herein as “Data Exchange 118(1).” Data Exchange 118(1) is used by data buyers 102 to create data orders for requested data that the buyers 102 are interested in buying. Thus, Data Exchange 118 provides a querying system for buyers 102 to communicate their data requirements by placing data orders on the blockchain. The use of on-chain operations provides a secure mechanism for exchanging data in the decentralized marketplace 100. Data Exchange 118(1) maintains references to the data orders created by data buyers 102 so that the data orders are accessible to other market participants, such as data sellers 104 and notaries 106. Data sellers 104 and notaries 106 can react to the data orders by agreeing to sell the requested data and agreeing to validate the requested data, respectively.

A data buyer 102 can indicate, in a data order, the intended audience and the requested data, which can both be specified using a data ontology 120. The data ontology 120 may be a publicly available document that formalizes naming, definition, structure and relationships for the marketplace's 100 data and can be used as a reference to generate audiences and data requests. The data ontology 120 may be comprised of a comprehensive variable list that defines available data entities, data query models for each variable type, and audience query models to filter available data sellers 104. Variables that are available in each category may be defined in the data ontology 120.

In a data order, a data buyer 102 (sometimes denoted as data buyer B) may request a particular data entity (e.g., browsing history) with additional parameters defined in the data query model (e.g., two days of history) from an audience defined in the audience query model (e.g., men who reside in Spain). Here, the “data entity” is specific data, or a type of data, owned by a data seller 104 (sometimes denoted as data seller S). Examples of data entities, or types of data, include, without limitation, browsing history data, financial transaction data (e.g., historical credit card transactions), geolocation data, social network data, mobile phone call data and/or advertising (Ad) identifier (ID), etc. The “data query model” is a set of parameters that a data buyer 102 can use to define the specific data amount, quality and/or type requested within a particular data entity. Examples of data query models include, without limitation, a period (e.g., two days) of browsing history beginning on a particular date (e.g., Jan. 1, 2017), all online financial transactions (e.g., credit card transactions that occurred on websites or mobile apps). The “audience query model” is a set of variables and values (or value ranges) that a data buyer 102 can use to request data from relevant data sellers 104.

A data order (DO) 122 can be placed on-chain by the data buyer 102, as shown in Step 1 of FIG. 1A. Such a data order 122 can include, without limitation: (i) audience A, (ii) requested data R, (iii) price p, (iv) hash of the terms and conditions of data use: H(tc), (v) public address (e.g., public Uniform Resource Locator (URL)) to upload data sellers' 104 responses and encrypted data via Hypertext Transfer Protocol Secure (HTTPS) POST requests for the data order: U_{B}. The audience A acts as a filter of potential sellers 104 for the data order 122, written in terms of the audience query model defined in a published data ontology 120. In an example, the audience A specified in a data order 122 may comprise: Gender=Women, Age ≥40, Income ≥$200,000, Current Residency=Spain. The requested data R may be a set (e.g., in list form) of data entities with certain parameters (as defined in the data query model), in addition to the audience. Examples of requested data include, without limitation, financial transaction data (e.g., credit card transactions) over a period of time (e.g., over the last seven days), desktop browsing history over a period of time (e.g., over the last thirty days), geolocation data, social network data, mobile phone call data and/or mobile phone Ad ID, etc. In some embodiments, the requested data R can be empty within the data order 122.

As mentioned, the data order 122 may include a public address of the data buyer 102, such as a public URL address, where the data buyer 102 can publish additional information, and where the data buyer 102 can receive data (e.g., encrypted data of sellers 104 who have selected a data order 122, encrypted cryptographic keys from notaries 106, etc.). The public address of the buyer 102, for instance, may host additional information about a specific data order 122 created by the buyer 102, the additional information including, without limitation: (i) the data buyer's 102 public key PK_{B}, (ii) the name of the buyer 102—if the buyer does not wish to remain anonymous, (iii) a description of the buyer 102, (iv) the buyer's 102 logo, (v) the complete text of the terms and conditions of data use tc, whose hash H(tc) matches the hash published in the data order 122, (vi) intended use of data (e.g., chosen between predefined categories), (vii) list of accepted notaries 106 for the data order 122, along with their fees, terms of services, and signatures L={N₁ . . . Nₛ}. Buyers 102 can specify notaries 106 who are eligible to audit data transactions, based on a match between the requested data R and the notary's 106 verification capabilities.

With reference again to the smart contracts 118, a second smart contract 118(2) of the marketplace 100 is also referred to herein as “Batch Payments 118(2).” Batch Payments 118(2) provides a payment protocol that enables the direct transfer of payments between participants (e.g., data buyers 102, data sellers 104, notaries 106, and, in some cases, delegates (See FIG. 1B)) of the marketplace 100. One challenge for the viability and scaling of blockchain networks is managing the costs of smart contract transactions. That is, there is a cost associated with invoking a smart contract 118 method. In the Ethereum blockchain, this cost is called “gas.” Gas is a unit of measurement that determines how much computation an EVM opcode requires. The price of one unit of gas is set in Ether and is known as the “gas price”. The gas price is used to calculate the total transaction fee for invoking a method call of a smart contract 118 based on how much gas the method requires, and it is to be paid by the sender of the transaction. Accordingly, Batch Payments 118(2) manages the costs of smart contract 118 transactions at least in part by batching multiple payments (which are each associated with a smart contract 118 transaction) together into a single batch of payments, and performing a single smart contract 118 transaction to pay potentially multiple participants, which helps to reduce transaction costs (e.g., gas costs) associated with operations in the blockchain. In some embodiments, smart contract 118 transactions are implemented using ERC20 tokens on the Ethereum blockchain. In this scenario, Batch Payments 118(2) acts as a proxy scaling solution for the transfer of ERC20 tokens. It is suitable for micropayments in one-to-many and few-to-many scenarios, including digital markets, such as the marketplace 100. It is to be appreciated that, although ERC20 tokens and Ethereum smart contracts are described herein, these are merely examples of smart contracts 118 and tokens that can be used with the techniques and systems described herein, and other blockchain-based smart contracts 118 and tokens are contemplated for use with the techniques and systems described herein.

In some embodiments, Batch Payments 118(2) operates by bundling together similar operations into a single transaction in order to optimize gas consumption. In addition, some costly verifications may be replaced by a challenge game, pushing most of the computing cost off-chain. This results in a large gas reduction in transfer costs. In addition, Batch Payments 118(2) includes relevant features, like meta-transactions for end-user operation without Ether, and key-locked transfers for atomic exchange of digital goods. In some embodiments, Batch Payments 118(2) may include, without limitation, the following characteristics: (i) registration of multiple participants, where 32-bit account IDs can be used, (ii) buyers 102 add tokens to their Batch Payments 118(2) account in order to make payments, (iii) buyers 102 initiate payments by issuing a RegisterPayment transaction, which includes a per-destination amount and a somewhat-compressed list of seller IDs, and the accounts of buyers 102 and sellers 104 may be updated within the Batch Payments 118(2) smart contract, (iv) sellers 104 can wait to accumulate enough payments, then initiate (e.g., send) a collect transaction specifying a range of payments and a total amount corresponding to their account, where the total amount can be the sum of the payments that the seller 104 is collecting, (v) after a challenge period, the requested amount may be added to the seller's 104 account balance, and the seller 104 may withdraw the tokens in his account afterwards, and (vi) in the case of a dispute, the seller 104 may list the individual payments in which he/she is included, the challenger may select a single payment and request a proof of inclusion, and the loser pays for the verification game (stake). In an example, a token is a smart contract that may implement the ERC20 interface. In particular, a token can be an ERC20 token may use the Zeppelin's implementation Standard Token, with an initial supply of 9,000,000,000 tokens with nine decimals. It is to be appreciated that, in regards to item (iv) of this paragraph, the collect transaction can optionally be sent through a delegate 128. In this way, the seller 104 can send the collect transaction without using Ether. The delegate 128 can send a transaction on behalf of the seller 104 to the Batch Payments smart contract 118(2) specifying which payments are to be transferred to the seller's 104 account. The delegate 128 can provide this service in exchange for a fee in tokens.

As mentioned, the marketplace 100 is decentralized, allowing for any participant which qualifies to enter the marketplace 100 as a data buyer 102, a data seller 104, a notary 106, or, in some cases, a delegate (See FIG. 1B), and there is no central authority to control the participation in the market 100 or to give/deny permission to act in the marketplace 100. Any participant may download a client app 108 to his/her computing device 110/112/114, which causes the computing device 110/112/114 to function as a node of a blockchain network (e.g., the Ethereum network), such as to execute smart contracts and call methods thereof. A “node” of the blockchain network can execute on-chain operations by sending transactions to the public address of the smart contract 118, the transaction specifying a method that is to be invoked. The result of such a method call is written to the blockchain after the transaction is mined.

In some embodiments, certain criteria may need to be satisfied in order to participate in the marketplace 100 as a data buyer 102. For example, the data buyer 102 may need: (i) a blockchain-based address (e.g., an Ethereum address) to send and receive payments (e.g., via Batch Payments 118(2)), (ii) public/private keys for signing transactions and encrypting data, (iii) a public (or off-chain) address, such as a public URL or an Internet Protocol (IP) address, to receive data responses, (iv) to be registered in the Batch Payments smart contract 118(2). Upon registration with Batch Payments 118(2), the data buyer 102 may receive a buyer identifier B_{ID}. In some embodiments, the data buyer 102 may register with the Data Exchange smart contract 118(1) as well.

In some embodiments, certain criteria may need to be satisfied in order to participate in the marketplace 100 as a data seller 104. For example, the data seller 104 may need: (i) a master blockchain-based address (e.g., a master Ethereum address) to send and receive payments, (ii) public/private keys for signing transactions and encrypting data, (iii) audience attributes, (iv) to be registered in the Batch Payments smart contract 118(2). Upon registration with Batch Payments 118(2), the data seller 104 may receive a seller identifier S_{ID}. In some embodiments, the data seller 104 may register with the Data Exchange smart contract 118(1) as well.

In some embodiments, certain criteria may need to be satisfied in order to participate in the marketplace 100 as a notary 106. For example, the notary 106 may need: (i) a blockchain-based address (e.g., an Ethereum address) to send and receive payments, (ii) public/private keys for signing transactions and encrypting data, (iii) a public address, such as a public URL, to receive data, (iv) to be registered in the Batch Payments smart contract 118(2). Upon registration with Batch Payments 118(2), the notary 106 may receive a notary identifier N_{ID}. The notary 106 may also register with the Data Exchange smart contract 118(1) and publish the public address of the notary 106, which establishes a link between the on-chain and off-chain worlds. In some embodiments, the notary 106 may need to reveal its public identity, such as by publishing its blockchain-based address (e.g., Ethereum address) and public key in a publicly verifiable place. Additionally, the notary 106 may publish, via the notary's 106 public address (e.g., public URL), its notarization fees (e.g., by type of data, per person, etc.) and terms of service.

FIG. 1A illustrates an example protocol for the exchange of data between a data buyer 102 and a data seller 104, which may be partitioned into separate phases: a setup phase, and a transaction phase. At Step 1 of FIG. 1A, during a setup phase, a buyer device 110 may receive user input from a data buyer 102 to create a new data order 122 for requested data. The buyer 102 may specify parameters of the data order 122, such as by using a data order (DO) query expressed as DO= [symbol] A, R, p, H(tc), U_{B} [symbol] in Data Exchange 118(1). The data order (DO) 122 may include parameters such as, without limitation: (i) audience A, (ii) requested data R, (iii) price p, (iv) hash of the terms and conditions of data use: H(tc), (v) public address (e.g., public URL, IP address, etc.) to upload responses and encrypted data from data sellers' 104 via HTTPS POST requests for the data order: U_{B}. The public address (e.g., public URL, IP address, etc.) may host additional information for the specific data order 122, including the data buyer's 102 public key PK_{B} and a list of accepted notaries for the data order L={N₁ . . . Nₛ}. To place the data order 122 with the specified parameters, the buyer device 110 (via a client app 108 executing thereon) may execute first instructions to call a first method of the Data Exchange smart contract 118(1), and the buyer device 110 may receive an ID for the data order (Data Order ID: DO_{ID}) in return. The creation of the data order 122 may cause an event to be emitted via the blockchain so that participants of the marketplace 100 are aware of this new data order.

With the data order 122 created in Data Exchange 118(1), the notary device 114 may provide a notification of this data order 122, and the notary 106 can indicate its agreement to validate requested data for the newly-created data order 122 by providing user input to the notary device 114. In response to this user input, the notary 106 may be listed as one of the available notaries for auditing the exchange of data associated with the newly-created data order 122. The notary device 114 (via its client app 108 executing thereon) may also generate a master key M that is usable to encrypt cryptographic keys generated by seller devices 112 of sellers 104 who indicate that they are interested in selling their data to the data buyer 102 in fulfillment of the data order 122. The notary device 114 may also generate a lock (e.g., Lock=H(N_{ID}∥M), and may send the lock to the public address of the buyer 102, which is specified in the data order 122. This lock can be used by the buyer 102 with the Batch Payments smart contract 118(2) at a later time, during a transaction phase, as described below.

At Step 2 of FIG. 1A, sellers 104 can monitor data orders 122 that have been created using the Data Exchange smart contract 118(1) in order to look for opportunities where they match the audience A, agree on the requested data R, accept the price p offered by the data buyer 102, accept the terms and conditions of data use tc, and accept one of the suggested notaries 106 in the set of notaries L. For example, the client app 108 of the seller device 112 may cause a set of data orders 122 for requested data to be displayed on the seller device 112. FIG. 1A shows examples of a first data order 122(1) and a second data order 122(2). In the first example data order 122(1), Buyer X is offering to purchase social network data from sellers 104 at a price of 38 tokens per seller 104. In the second example data order 122(2), Buyer Y is offering to purchase geolocation data from sellers 104 at a price of 46 tokens per seller 104. In this example, the data buyer 102 may represent either Buyer X or Buyer Y.

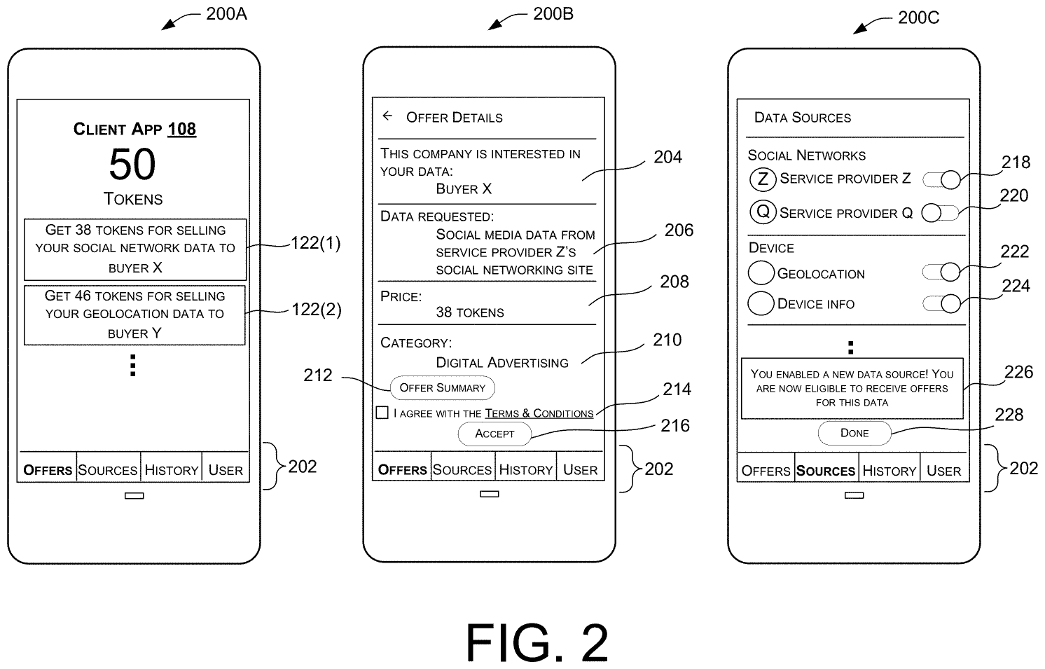

To better illustrate what a seller 104 sees on a display of his/her seller device 104 at Step 2 of FIG. 1A, reference is now made to FIG. 2, which illustrates three example user interfaces 200A, 200B, and 200C of a client application 108 that can be displayed on a computing device 112 of a data seller 104. The user interface 200A presents a number of tokens indicating a current balance (e.g., 50 tokens) in the account of the data seller 104. The user interface 200A also presents two example data orders, 122(1) and 122(2), which were introduced in FIG. 1A. A menu bar 202 at the bottom of the user interface 200A may indicate, to the data seller 104, that the client app 108 is currently showing available “offers” from data buyers 102.

If the seller 104 provides user input to select one of the displayed data orders 122, such as the displayed data order 122(1), the client app 108 may navigate the seller 104 to the user interface 200B. The user interface 200B may present the offer details of the selected data order 122(1). The offer details presented on the user interface 200B may indicate the various parameters of the data order 122(1) that were specified by the data buyer 102 and/or may include additional information about the data buyer 102 and/or about the data order 122(1). For example, the user interface 200B may display, in a section 204, a friendly name of the data buyer 102—if the buyer 102 does not wish to remain anonymous, such as a name of an individual or company, and/or a logo (e.g., “Buyer X”). In a section 206 of the user interface 200B, the requested data R may be displayed (e.g., social media data from service provider Z's social networking site). In a section 208 of the user interface 200B, the price p offered by the data buyer 102 for the requested data R may be displayed (e.g., 38 tokens). In a section 210 of the user interface 200B, a category of intended data use may be displayed (e.g., digital advertising). The category of intended data use might inform the data seller 104 that his/her data is to be used for a particular purpose, such as for digital advertising. This provides the seller 104 with transparency as to how his/her data will be used. The user interface 200B may display an offer summary button 212 for selection by the data seller 104, which, upon selection, may navigate to a different page, or may present a pop-up area, which may display additional information about the data order 122(1). Such additional information displayed in response to selection of the offer summary button 212 may include, without limitation, a set of notaries 106 L that are available for use in validating the requested data R of the data order 122(1). A link (e.g., a hyperlink, in-app link, etc.) to terms and conditions 214 may also be displayed to the seller 104. When the link is selected, the client app 108 may navigate the seller 104 to more details regarding how the requested data R can be used by the data buyer 102, which provides even more transparency regarding the intended data use. By selecting an accept button 216 of the user interface 200B, the data seller 104 can indicate his/her acceptance of the terms and conditions 214 and his/her agreement to sell his/her data to the data buyer 102 who created the data order 122(1), thereby placing the seller 104 in control of whether and how his/her data is used, and by whom. In some embodiments, the data seller 104 may be required to select/check a box to explicitly accept the terms and conditions 214 before the accept button 216 is enabled for selection. Selection of the accept button 216 may cause the seller device 112 to receive an indication of that the data order 122(1) has been selected by the seller 104, which triggers a transaction phase of the protocol. Before describing this transaction phase with reference to FIG. 1A, the user interface 200C will be briefly described.

The user interface 200C of FIG. 2 illustrates an example “sources” page of the client app 108 (as indicated by the menu bar 202), which allows the data seller 104 to select (e.g., “turn on” or activate) different types of data sources to become eligible to receive offers (data orders 122) for a particular type of data. For example, the data seller 104 can toggle a soft button 218 to “turn on” a data source pertaining to service provider Z, which represents a fictitious entity that provides social networking services to consumers. The data seller 104 might toggle another soft button 220 to “turn off” a data source pertaining to service provider Q—another fictitious entity that provides social networking services to consumers—so that the seller 104 is not eligible to receive data orders 122 pertaining to such data. The user interface 200C may display additional soft buttons 222, 224 that the seller 104 can toggle on/off in order to “turn on/off” other data sources, like a geolocation data source and/or a device info data source. In this manner, the seller 104 can decide specific types of data that he/she is willing to sell to buyers 102 via the marketplace 100, putting the control of the seller's 104 data in his/her hands. The seller 104 can change these settings at any time to control the use of his/her data. The user interface 200C may display a message whenever the seller 104 toggles one of the soft buttons 218-224 “on” or “off,” which provides feedback to the seller 104 that they have just enabled or disabled a new data source by providing user input to toggle a soft button 218, 220, 222, or 224. A “done” button 228 may be selected in order to save the seller's 104 settings in regards to enabled/disabled data sources.

Turning back to FIG. 1A, an example transaction phase of the protocol will now be described. Consider an example where the seller 104 selects one of the data orders 122 displayed on the seller device 112 via the client app 108. In response to such selection, the seller device 112 receives an indication of the same, and the seller device 112 can encrypt relevant data 124 owned by the seller 104 using a cryptographic key K_{S}. This cryptographic key K_{S} can be generated, by the client app 108 of the seller device 112 as a random cryptographic key K_{S}, and the key K_{S} may be discarded after use with respect to the selected data order 122. That is, the client app 108 may be configured to generate a new random cryptographic key K_{S} for each data order 122 selected by the seller 104. The data 124 that is encrypted may be stored in memory of the seller device 112, or in a storage location that is otherwise accessible to the seller device 104, such as a network accessible storage location. To obtain the data 124 in the first place, the client app 108 may authenticate the seller 104 and/or the seller device 112 with a source of the data 124 (e.g., a company, such as the notary 106, who possesses previously-collected data 126, some of which pertains to the data seller 104), and, once authenticated, the seller device 112 may download the data 124, or the seller device 122 may otherwise access the data 124 in real-time, for encryption of the data 124.

In an illustrative example, the requested data R of a selected data order 122 may comprise financial transaction data of the data seller 104, which may be associated with a payment instrument issued by a bank (the bank may be a suitable notary 106 in this case). Accordingly, the client app 108 may authenticate the seller 104 with the bank's server computers using any suitable authentication procedure (e.g., username, passwords, PINs, biometric verification, etc.), and, if authenticated, may download the seller's 104 financial transaction data as the data 124 to be encrypted and eventually sold to the data buyer 102 in unencrypted form. As another example, the requested data R of a selected data order 122 may comprise geolocation data of the data seller 104, which may have been generated using a Global Positioning System (GPS) receiver of a mobile phone carried by the seller 104. In this example, the seller 104 may be a subscriber of telecommunications services provided by a telecommunications company (the telecommunications company may be a suitable notary 106 in this case). Accordingly, the client app 108 may authenticate the seller 104 with the telecommunication company's server computers using any suitable authentication procedure, and, if authenticated, may download the seller's 104 geolocation data as the data 124 to be encrypted and eventually sold to the data buyer 102 in unencrypted form.

At Step 3A, the seller device 112 may send the encrypted data 124 and the cryptographic key K_{S} (which was used to encrypt the data 124) to a public address of the notary 106, such as a public URL or IP address of the notary 106. This notary 106 may be selected from the set of available notaries 106 L specified in the selected data order 122, and the notary's 106 public address may be obtained from information in the data order 122 and/or from information that is hosted at the buyer's 102 public address (the public address of the data buyer 102 included in the data order 122). The data 124 that is encrypted using the cryptographic key K_{S} may be expressed as: C_{S}=E_{K}_{_{S}}(Data_{S}). In some embodiments, the encrypted data 124 C_{S}=E_{K}_{_{S}}(Data_{S}) and cryptographic key K_{S} may be sent in a message to the public address of the notary 106 at Step 3A, and this message may further include, without limitation, (i) an identifier of the selected data order 122 (Data Order ID: DO_{ID}), (ii) an identifier of the seller 104 that is associated with the second smart contract 118(2) (e.g., a Batch Payments 118(2) seller ID: S_{ID}), (iii) a blockchain-based seller address (e.g., an Ethereum seller address Sₑₜₕ)—if the seller 104 does not have a Batch Payments 118(2) seller ID: S_{ID}.

At Step 3B, the seller device 112 may also send the encrypted data 124 C_{S}=E_{K}_{_{S}}(Data_{S}) to the public address of the data buyer 102. The public address of the data buyer 102 may be determined from the selected data order 122. Notably, the seller device 112 sends the encrypted data 124 C_{S}=E_{K}_{_{S}}(Data_{S}) to the public address of the data buyer 102 without sending the cryptographic key K_{S} to the buyer 102. This is so that the data 124 remains inaccessible to the data buyer 102 until the notary 106 reveals the master key M, as described in detail below. In some embodiments, the encrypted data 124 C_{S}=E_{K}_{_{S}}(Data_{S}) may be sent in a message to the public address of the buyer 102 at Step 3B, and this message may further include, without limitation, (i) an identifier of the selected data order 122 (Data Order ID: DO_{ID})), (ii) an identifier of the seller 104 that is associated with the second smart contract 118(2) (e.g., a Batch Payments 118(2) seller ID: S_{ID}), (iii) a blockchain-based seller address (e.g., an Ethereum seller address Sₑₜₕ)—if the seller 104 does not have a Batch Payments 118(2) seller ID: S_{ID}, (iv) a blockchain-based notary address (e.g., an Ethereum notary address Nₑₜₕ) of the selected notary 106 N∈L; the set of L notaries 106 having been specified in the data order 122, (v) a Boolean value (e.g., NeedsBuyerRegistration nbr: Boolean (for the Batch Payments 118(2) registration)), where this Boolean value indicates whether the data seller 104 is to be automatically registered with the Batch Payments smart contract 118(2). For example, if the Boolean value is set to a first value of “True”, the seller 104 is to be automatically registered with the Batch Payments smart contract 118(2), and if the Boolean value is set to a second value of “False”, the seller 104 should not be automatically registered with the Batch Payments smart contract 118(2).

The sending of messages to public addresses of market participants, as described with reference to Steps 3A and 3B of FIG. 1A, are examples of “off-chain” operations. An off-chain message structure may comprise a payload field that contains the contents of the message (e.g., encrypted data 124), and a signature field that contains the sender's signature of the payload field. An off-chain message may be encrypted with a public key of the recipient (e.g., using Elliptic Curve Digital Signature Algorithm (ECDSA)) before being sent to the recipient. In addition, the seller 104 may remain anonymous, if desired, by not revealing the seller's name or identity. The identifiers associated with the seller may not be used to discover the actual name or identity of the seller 104.

At Step 4 of FIG. 1A, the buyer device 110 of the data buyer 102 may send, to a public address of the notary 106, an identifier of a data seller 104 that the buyer 102 has selected, as well as a hash of the encrypted data 124 C_{S}=E_{K}_{_{S}}(Data_{S}) provided by that seller 104 who selected the data order 122. For example, the buyer 102 may use his/her buyer device 110 to access his/her public address (e.g., the public URL of the data buyer 102). This allows the data buyer 102 to browse identifiers of a set of data sellers 104 who have selected the buyer's 102 data order 122, thereby indicating their agreement to sell the requested data R to the data buyer 102. For example, when the public address of the data buyer 102 is accessed using the buyer device 110, a set of one or more seller identifiers are presented for selection on a display of the buyer device 110. When the buyer 102 selects the identifier of the seller 104 in FIG. 1A, thereby confirming that the buyer 102 is interested in the requested data R of that seller 104, the buyer device 110 receives an indication that this seller identifier has been selected by the data buyer 102, and the buyer device 110 may respond by receiving (e.g., download), via the public address of the data buyer 102 (e.g., by issuing a HTTPS GET request), the encrypted data 124 C_{S}=E_{K}_{_{S}}(Data_{S}) that the seller 104 posted to the buyer's 102 public address. The buyer device 110 may then generate a hash h_{S}=H(C_{S}) of the encrypted data 124 C_{S}=E_{K}_{_{S}}(Data_{S}), and may send the hash h_{S} and the identifier of the seller 104 S_{ID} to the public address of the notary 106 at Step 4.

It is to be appreciated that the buyer 102 can select more than one seller identifier to confirm his/her interest in buying from multiple data sellers 104 for a given data order 122. For example, the buyer 102 may select a set T of data sellers 104 from whom he/she wants to buy, and may send, at Step 4 of FIG. 1A, a message containing the list of corresponding seller identifiers S_{ID} (or seller addresses) to the public address of the notary 106, and this message may include, without limitation: (i) an identifier of the data order 122 (Data Order ID: DO_{ID}), (ii) a callback public address (e.g., callback URL or IP address) to receive the response from the notary 106, (iii) the list of the sellers 104 to be notarized (e.g., the sellers selected in the set T of sellers 104). For each seller S in the set/list of T, the message sent from the buyer device 110 to the public address of the notary 106 may further include, without limitation: (i) an identifier of the seller 104 that is associated with the second smart contract 118(2) (e.g., a Batch Payments 118(2) seller ID: S_{ID}), (ii) a blockchain-based seller address (e.g., an Ethereum seller address Sₑₜₕ), (iii) a hash of the encrypted data 124 h_{S}=H(C_{S}) and/or a hash of the seller's 104 cryptographic key K_{S}: h_{S}=H(K_{S})—if the seller 104 sent the hash of his/her cryptographic key K_{S} to the buyer 102.

At Step 5 of FIG. 1A, the notary 106 can validate the seller's data 124, encrypt the cryptographic key K_{S} of the seller 104—using the master key M it generated—to obtain an encrypted cryptographic key ck_{S}=E_{M}(K_{S}), and send the encrypted cryptographic key ck_{S} to the public address of the data buyer 102. For example, because the seller 104 sent the encrypted data 124 C_{S}=(Data_{S}) and the cryptographic key K_{S} to the notary 106 at Step 3A of FIG. 1A, the notary can compute Data_{S}=D_{K5}(C_{S}) and validate the data 124, if required. In other words, if the data 124 of the seller 104 is to be validated, the notary 106 may use the cryptographic key K_{S} it received from the seller 104 to decrypt the encrypted data 124 to obtain the data 124 of the data seller 104. The notary 106 may then compare the data 124 (unencrypted) of the data seller 104 with previously-collected data 126 of the data seller 104 that is maintained in a database accessible to the notary 106 (e.g., ground truth data) to generate a notarization result, which indicates whether the data 124 of the data seller 104 is valid (approved) or invalid (rejected). The notary 106 can perform validation of participants' information and/or validation of the data 124 off-chain, and the notary 106 is incentivized to do so by the fact that the notary 106 will receive a payment for each notarization, which, in turn, incentivizes honest behavior of marketplace 100 participants.

The notary 106 can also verify that it has the same seller data 124 as the buyer 102 has in his/her possession based on the hash value the buyer device 110 sent to the public address of the notary 106. For example, the notary device 114 may verify that a hash of the seller's 104 encrypted data C_{S} equals the hash value received from the buyer device 110, or H(C_{S})=h_{S}. Said another way, the notary device 114 may receive, via the public address of the notary 106, a first hash value that was provided by the data buyer 102, and may determine that a second hash value generated based at least in part on the encrypted data 124 of the data seller 104 matches the first hash value.

After the notary 106 performs the notarization and approves the data 124, the notary device 114 may encrypt the cryptographic key K_{S} using a master key M to obtain an encrypted cryptographic key ck_{S}=E_{M} (K_{S}), and the notary device 114 may send, to the public address of the data buyer 102, the encrypted cryptographic key ck_{S} and the notarization result(s) for the seller 104, such as an indication that the data 124 of the seller 104 was validated by the notary 106.

It is to be appreciated that a single master key M can be used to encrypt multiple cryptographic keys of multiple data sellers 104 selected by the data buyer 102 for a transaction involving the data buyer 102 for the requested data R. For example, the notary 106 may build a list of notarization results for data 124 notarized for multiple sellers 104, the list including, without limitation, for each seller 104: (i) an identifier of the seller 104 that is associated with the second smart contract 118(2) (e.g., a Batch Payments 118(2) seller ID: S_{ID}), (ii) a blockchain-based seller address (e.g., an Ethereum seller address Sₑₜₕ), (iii) a notarization result specifying one of the following: (a) the data 124 will not be notarized, (b) the data 124 was notarized and is valid (approved), or (c) the data 124 was notarized and is invalid (rejected), (iv) an encrypted key ck_{S}=E_{M}(K_{S}). The notary device 114 may send, at Step 5 of FIG. 1A, this list of sellers 104 containing notarization results and encrypted keys, along with additional data in a message to the public address of the data buyer 102, the message including, without limitation, (i) an identifier of the selected data order 122 (Data Order ID: DO_{ID}), (ii) a notarization fee for the service performed, (iii) a notarization percentage applied (e.g., a percentage of sellers to be notarized that were actually audited)—the notary 106 can decide which data sellers 104 are notarized, (iv) a blockchain-based notary address (e.g., an Ethereum notary address Nₑₜₕ), (v) a hash of the pay data payDataHash to be sent to the Batch Payments smart contract 118(2) (e.g., a list of seller IDs written in an efficient way), (vi) if the lock was not sent to the buyer's public address previously, the lock that the buyer 102 is to send to the Batch Payments smart contract 118(2), such as a lock in the form of Lock=H(N_{ID}∥M).

At Step 6 of FIG. 1A—after the buyer device 110 receives the encrypted cryptographic key and the notarization result(s) via the public address of the buyer 102—the buyer device 110 may execute instructions to call a method of the Batch Payments smart contract 118(2), the method specifying an identifier(s) of a seller(s) 104 and an identifier of the notary 106 to authorize respective payments to be made to respective accounts of the data seller(s) 104 and the notary 106. For example, the buyer device 110 may execute instructions (via the client app 108) to call a RegisterPayment method of the Batch Payments smart contract 118(2), specifying the address of the seller(s) 104. The method of the Batch Payments smart contract 118(2) called by the buyer device 110 may also specify the lock that the buyer 102 received from the notary 106. It is to be appreciated that the list of sellers added to Batch Payments 118(2) at Step 6 of FIG. 1A may be a filtered list of sellers 104 (filtered by removing the rejected sellers). The method called by the buyer device 110 at Step 6 may include, without limitation, the following parameters: (i) an identifier of the selected data order 122 (Data Order ID: DO_{ID}), (ii) an identifier of the seller 104 that is associated with the second smart contract 118(2) (e.g., a Batch Payments 118(2) seller ID: S_{ID}), (iii) the lock in the form of Lock=H(N_{ID}∥M), (iv) the notarization fee for the service performed by the notary 106, (v) a blockchain-based notary address (e.g., an Ethereum notary address Nₑₜₕ) of the notary 106, (vi) a notary signature. Thus, the buyer 102 may publish, on the blockchain, the selected seller(s) 104, the price paid for the requested data R, and the hashes of the data.

At Step 7 of FIG. 1A, the notary device 114 may execute instructions to call a method of the Batch Payments smart contract 118(2) to reveal the master key M. For example, the notary device 114 may execute instructions (via the client app 108) to call an UnlockPayment method of the Batch Payments smart contract 118(2). The method of Batch Payments 118(2) called by the notary device 114 at Step 7 may include, without limitation, the following parameters: (i) a Batch ID, (ii) the master key M. This triggers the Batch Payments smart contract 118(2) to transfer payments of tokens from the buyer's 102 account into the respective accounts of the data seller(s) 104 and the notary 106. At an earlier point in time, the buyer 102 may have registered with Batch Payments 118(2) and added tokens to his/her account, which can be drawn from to make these payments. In addition, the buyer device 110 can verify the published master key M by checking that H(N_{ID}∥M)=Lock, use the master key M to decrypt the encrypted key ck_{S}=E_{M}(K_{S}) (i.e., compute K_{S}=D_{M}(C_{K}_{_{S}})) to obtain the cryptographic key K_{S} of the seller 104, and use the cryptographic key K_{S} to decrypt the encrypted data 124 (i.e., compute Data=D_{K}_{_{S}}(C_{S})) of the seller 104 to obtain the data 124 of the seller 104. In other words, the revelation of the master key M allows the buyer 102 to gain access to the seller's 104 data 124, in unencrypted form. The use of the master key M to unlock payments and to provide the buyer 102 with access to the seller's 104 data 124 is an example of an atomic data exchange mechanism, whereby real-world private information is exchanged using cryptographic protocols and a public blockchain to guarantee the fairness of transactions for data. “Atomicity”, in this context, means that, once data 124 is revealed to the data buyer 102, the data seller(s) 104 receives a payment for the data 124, and the notary 106 receives a payment for validating the data 124—none of the events occur independently without the others also occurring.

At Step 8A of FIG. 1A, the seller device 112 may execute instructions to call a method of the Batch Payments smart contract 118(2) to receive (e.g., withdraw) a batch of payments that includes the payment for the data 124 sold to, and purchased by, the data buyer 102. Similarly, at Step 8B of FIG. 1A, the notary device 114 may execute instructions to call the method of the Batch Payments smart contract 118(2) to receive (e.g., withdraw) a batch of payments that includes the payment for notarizing the data 124 purchased by the data buyer 102. This method can be called at any time by the devices of the seller 104 and the notary 106.

Table 1, below, summarizes aspects of the protocol described with respect to FIG. 1A.

TABLE 1

| Seller S | Notary N | Buyer B |
|---|---|---|
| | M = Random( ) | |
| | Lock = H(N_{ID}∥M) | |
| | Send_{Buyer} (Lock) | |
| K_{S} = Random( ) | | |
| C_{S} = E_{K}_{_{S}}(Data_{S}) | | |
| Send_{Buyer}(C_{S}) | | |
| Send_{Notary}(C_{S}, K_{S}) | | |
| | | h_{S} = H(C_{S}) |
| | | Send_{Notary}(S_{ID}, h_{S}) |
| | Verify H(C_{S}) = h_{S} | |
| | ck_{S} = E_{M}(K_{S}) | |
| | Send_{Buyer}(ck_{S}) | |
| | | RegisterPayment(S_{ID}, |
| | | Lock) |
| | UnlockPayment(N_{ID}, M) | |

FIG. 1B is a diagram illustrating the marketplace 100 of FIG. 1A with the addition of a delegate 128 as a marketplace participant. The delegate 128 can be any entity that participates in the marketplace 100 by sending blockchain-based transactions on behalf of another participant(s) in exchange for a fee in tokens. For example, if certain participants, such as the notary 106 and/or the seller 104, do not possess any blockchain tokens (e.g., Ether) that are usable to invoke or call a smart contract method (e.g., a method of Batch Payments 118(2)), the delegate 128 can assist those market participants by submitting blockchain-based transactions on their behalf. A set of delegates, such as the delegate 128 of FIG. 1B, may be denoted herein as D={D₁, . . . , D_{q}}. In order to participate in the marketplace 100, a delegate 128 may be required to, without limitation: (i) have a blockchain-based delegate address (e.g., an Ethereum delegate address Dₑₜₕ), (ii) register in the Batch Payments smart contract 118(2)—upon registration, the delegate 128 may receive an identifier D_{ID}, (iii) have capital (e.g., blockchain tokens in an account of the delegate 128) in order to operate in the Batch Payments 118(2) system.

The protocol of FIG. 1B may be similar to the protocol described with respect to FIG. 1A, and, to the extent that they are similar, the operations/steps and actors of FIG. 1B will not be described again for the sake of brevity, as reference can be made to FIG. 1A for this purpose. However, an example difference between the protocols of FIGS. 1A and 1B is that, at Step 7 of FIG. 1B, a delegate device 130 (which may be any suitable type of computing device, as described with respect to the devices 110/112/114 of FIG. 1A) associated with the delegate 128 may execute instructions to call a method of the Batch Payments smart contract 118(2) to reveal the master key M. The delegate 128 can perform an unlock, if requested by the notary 106. To do this, the notary 106 can authorize the delegate 128 at any suitable time (e.g., at a point in time prior to the instant transaction), and the notary 106 can use the notary device 114 to transfer the master key M to the delegate device 130. In an example, the delegate device 130 may execute instructions (via a client app 108 executing thereon) to call an UnlockPayment method of the Batch Payments smart contract 118(2). The method of Batch Payments 118(2) called by the delegate device 130 at Step 7 of FIG. 1B may include, without limitation, the following parameters: (i) a Batch ID, (ii) the master key M. This triggers the Batch Payments smart contract 118(2) to transfer payments of tokens from the buyer's 102 account into the respective accounts of the data seller(s) 104 and the notary 106, and the buyer device 110 can verify the published master key M by checking that H(N_{ID}∥M)=Lock, use the master key M to decrypt the encrypted key ck_{S}=E_{M}(K_{S}) (i.e., compute K_{S}=D_{M}(C_{K}_{_{S}})) to obtain the cryptographic key K_{S} of the seller 104, and use the cryptographic key K_{S} to decrypt the encrypted data 124 (i.e., compute Data=D_{K}_{_{S}}(C_{S})) of the seller 104 to obtain the data 124 of the seller 104. It is to be appreciated that the delegate 128 (and/or the delegate device 130) may perform at least some of the functions described with reference to FIG. 1A as being performed by the notary 106 (and/or the notary device 114). Although FIG. 1B depicts Steps 8A and 8B as being performed by the seller device 112 and the notary device 114, respectively, the operation of executing instructions to call a method of Batch Payments 118(2) to receive a batch of payments (e.g., paid to the notary 106 and/or the seller 104) may be performed by the delegate device 130, in some embodiments, and the received payments may then be transferred from the delegate 128 to relevant participant (e.g., the notary 106, the seller 104, etc.). In an example, the delegate 128 can send a collect transaction on behalf of the seller 104 to the Batch Payments smart contract 118(2) specifying which payments are to be transferred to the seller's 104 account. Similarly, the delegate 128 can send a collect transaction on behalf of the notary 106 to the Batch Payments smart contract 118(2) specifying which payments are to be transferred to the notary's 106 account. The seller 104 and the notary 106 may each employ their own delegates 128 for this purpose. The delegate 128 can provide this/these service(s) in exchange for a fee(s) in tokens. It is also to be appreciated that the delegate 128 may also receive a payment into an account of the delegate 128 for services provided by the delegate 128 on behalf of the notary 106.

The processes described in this disclosure may be implemented by the architectures described herein, or by other architectures. These processes are illustrated as a collection of blocks in a logical flow graph. Some of the blocks represent operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order or in parallel to implement the processes. It is understood that the following processes may be implemented on other architectures as well.

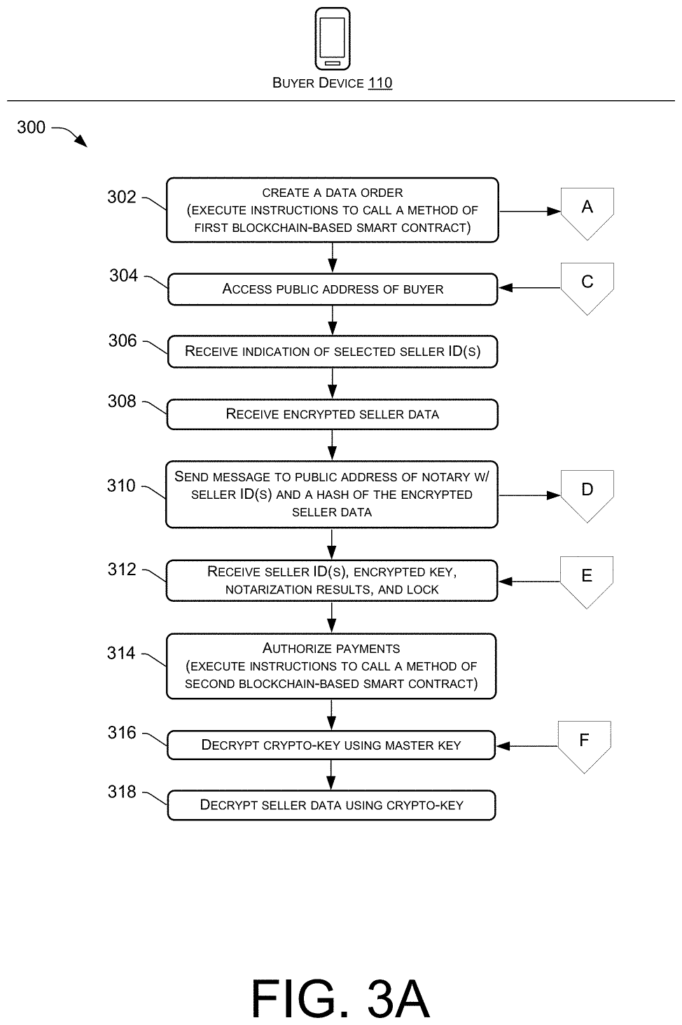

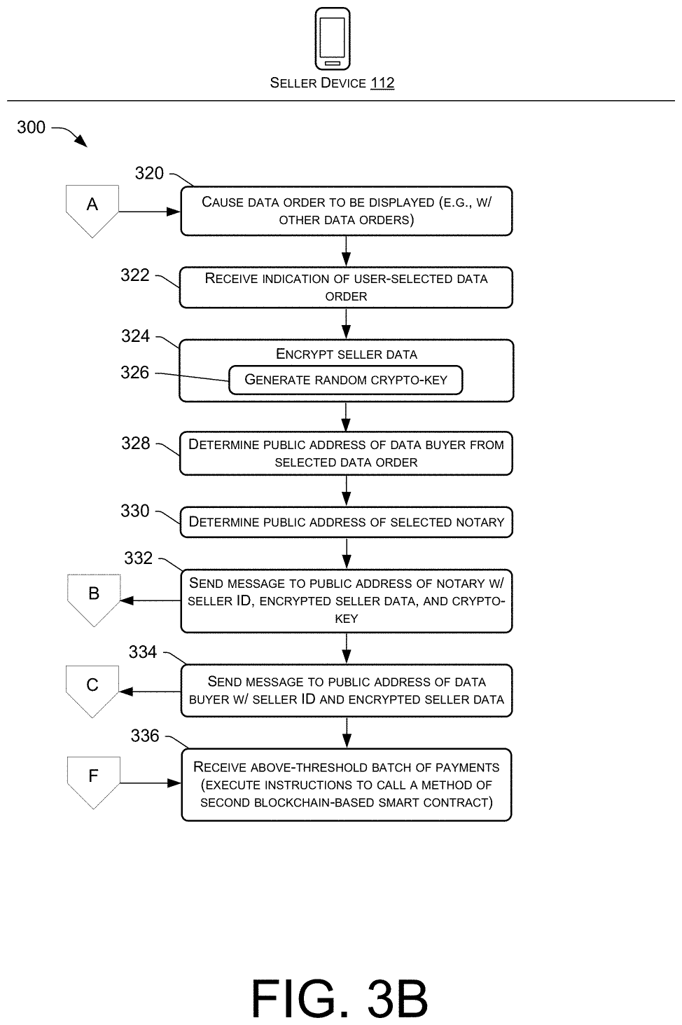

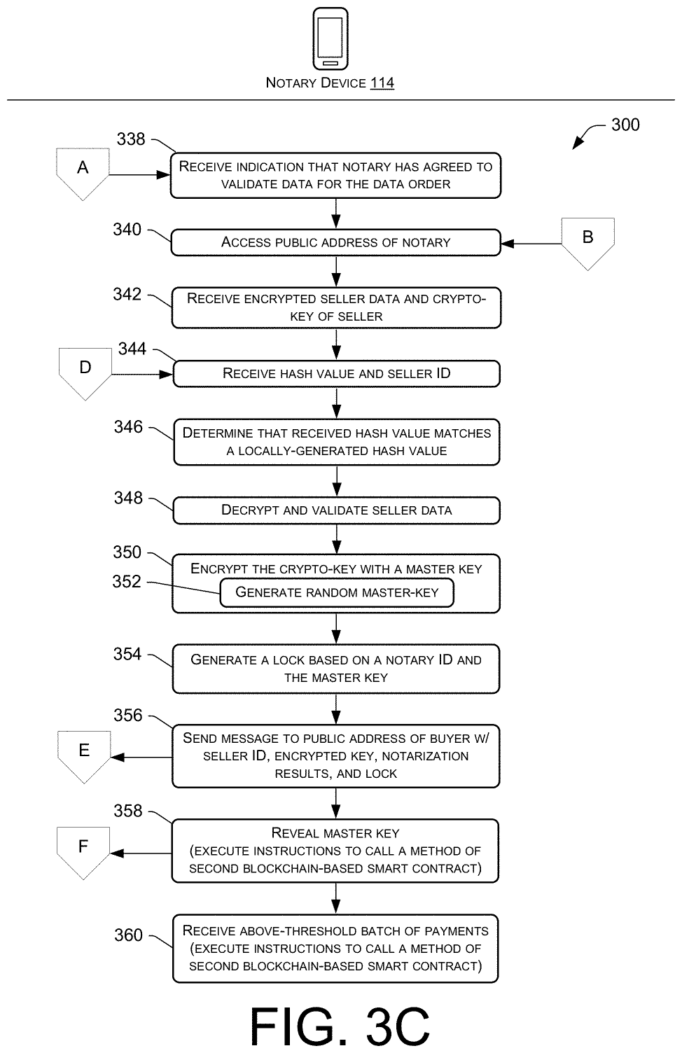

FIGS. 3A-3C illustrate a flowchart of an example process 300 for exchanging data via a blockchain-based, decentralized data marketplace. FIG. 3A illustrates example operations performed by a buyer device 110 during the data exchange process, FIG. 3B illustrates example operations performed by a seller device 112 during the data exchange process, and FIG. 3C illustrates example operations performed by a notary device 114 (and possibly some operations performed by a delegate device 130) during the data exchange process. For discussion purposes, the process 300 is described with reference to the previous figures. Furthermore, as shown by the off-page references A, B, C, D, E, and F in FIGS. 3A-3C, particular operations of the process 300 may, by way of example and not limitation, occur in a particular sequence.

At 302, a data order 122 is created. This may include the buyer device 110 receiving user input from a data buyer 102 to create a new data order 122 for requested data. The buyer 102 may specify parameters of the data order 122, such as by using a data order (DO) query expressed as DO= [symbol] A, R, p, H(tc), U_{B} [symbol] in Data Exchange 118(1). The data order (DO) 122 may include parameters such as, without limitation: (i) audience A, (ii) requested data R, (iii) price p, (iv) hash of the terms and conditions of data use: H(tc), (v) public address (e.g., public URL, IP address, etc.) to upload responses and encrypted data from data sellers' 104 via HTTPS POST requests U_{B} for the data order 122. The public address may host additional information for the specific data order 122, including the data buyer's 102 public key PK_{B} and a list of accepted notaries for the data order L={N₁ . . . Nₛ}. To place the data order 122 with the specified parameters at block 302, the buyer device 110 (via a client app 108 executing thereon) may execute first instructions to call a first method of the Data Exchange smart contract 118(1), and the buyer device 110 may receive an ID for the data order (Data Order ID: DO_{ID}) in return. The creation of the data order 122 at block 302 may cause an event to be emitted via the blockchain so that participants of the marketplace 100 are aware of this new data order 122, as indicated by the off-page reference “A” in FIGS. 3A-3C.

At 304, the buyer 102 may use the buyer device 110 to access his/her public address. As shown by off-page reference “C”, this may occur after the seller device(s) 112 of a seller(s) 104 sends a message at block 334 (See FIG. 3B) to the public address of the data buyer 102, the message including at least the seller's 104 identifier(s) and encrypted data 124 of the seller(s) 104. This accessing, at block 304, causes the buyer device 110 to present identifiers of data sellers 104 who have selected the data order 122 on a display of the buyer device 110. The data buyer 102 can browse the displayed identifiers of the data sellers 104 who have agreed to sell the requested data R to the data buyer 102. The accessing at block 304 may cause the buyer device 110 to present additional information on the display, such as an identifier of the data order 122, an Ethereum address of the notary 106 selected by each seller 104, and/or a Boolean value indicating whether each data seller 104 is to be automatically registered with the Batch Payments smart contract 118(2).

At 306, when the buyer 102 selects the identifier(s) of a seller(s) 104, thereby confirming that the buyer 102 is interested in the requested data R of the seller(s) 104, the buyer device 110 may receive an indication that this seller identifier(s) has/have been selected by the data buyer 102.

At 308, buyer device 110 may receive (e.g., download), via the public address of the data buyer 102, the encrypted data 124 C_{S}=E_{K}_{_{S}}(Data_{S}) that the selected seller(s) 104 posted to the buyer's 102 public address. For example, receiving the encrypted data 124 of the data seller(s) 104 at block 308 may comprises issuing a HTTPS GET request to the public address (e.g., public URL, public IP address, etc.) of the data buyer 102.

At 310, the buyer device 110 can generate a hash h_{S}=H (C_{S}) of the encrypted data 124 C_{S}=E_{K}_{_{S}}(Data_{S}), and may send, to a public address of the notary 106, a message that includes at least the identifier(s) of the data seller(s) 104 (which the buyer 102 has selected previously and wants the notary 106 to notarize) and the hash of the seller's 104 encrypted data 124 h_{S}=H(C_{S}). As shown by off-page reference “D”, this operation(s) performed at block 310 may lead to the operation(s) performed at block 344 (See FIG. 3C) where the notary device 114 receives the identifier of the seller(s) 104 S_{ID} and the hash value h_{S}. In some embodiments, the message sent at block 310 to the public address of the notary 106 may further include the identifier of the data order 122, a callback public address of the data buyer 102.

At 312, after the notary 106 validates the data 124, the buyer device 110 may receive, via the public address of the buyer 102, an identifier(s) of the data seller(s) 104, an encrypted cryptographic key of the data seller(s) 104, the notarization result(s) pertaining to each data seller 104 (e.g., an indication that the encrypted data 124 of the data seller 104 was validated by the notary 106), and a lock in the form of Lock=H(N_{ID}∥M) which was generated by the notary device 114. As shown by off-page reference “E”, the operation(s) performed at block 312 may result from operation(s) performed at block 356 (See FIG. 3C) where the notary device 114 sends a message to the public address of the data buyer 102 with the seller ID(s), encrypted key(s) of the seller(s) 104, notarization result(s) of the seller(s) 104, and the lock.

At 314, the buyer device 110 may authorize payments to be made to the sellers 104 whose data 124 was validated by the notary 106. For example, the buyer device 110 may execute instructions to call a method of the Batch Payments smart contract 118(2), the method specifying an identifier(s) of the data seller(s) 104 and an identifier of the notary 106 to authorize respective payments to be made to respective accounts of the data seller(s) 104 and the notary 106. For example, the buyer device 110 may execute, at block 314, instructions (via the client app 108) to call a RegisterPayment method of the Batch Payments smart contract 118(2), specifying the address(es) of the seller(s) 104 from whom the buyer 102 is purchasing the requested data R. The method of the Batch Payments smart contract 118(2) called by the buyer device 110 may also specify the lock that the buyer 102 received from the notary 106.

At 316, the buyer device 110 (via the client app 108) may decrypt the encrypted cryptographic key that was received from the notary 106. The buyer device 110 may decrypt the seller's key using a master key M that was revealed by the notary 106 via the Batch Payments smart contract 118(2), and, as a result, the buyer device 110 obtains the cryptographic key of the data seller 104. As shown by off-page reference “F”, the operation(s) performed at block 316 may result from operation(s) performed at block 358 (See FIG. 3C) where the notary device 114 reveals the master key M by calling a method of the Batch Payments smart contract 118(2).

At 318, the buyer device 110 (via the client app 108) may decrypt the encrypted data 124 of the data seller 104 using the cryptographic key of the data seller 104. As a result, the buyer device 110 obtains data 124 of the data seller 104, in unencrypted form, thereby gaining access to the data 124 the buyer 102 purchased.

Turning to FIG. 3B, example operations performed by the seller device 112 will now be described. At 320, and as a result of the data order 122 being created at block 302 (as indicated by off-page reference “A”), the seller device 112 may cause a set of data orders 122 for requested data to be displayed on a display of the seller device 112, one of those data orders 122 being the data order 122 created at block 302 of the process 300.

At 322, if the seller 104 selects one of the data orders 122 displayed on the seller device 112 via the client app 108, the seller device 112 may receive an indication of the selected data order 122, among the set of data orders 122.

At 324, the seller device 112 (via the client app 108) can encrypt relevant data 124 owned by the seller 104 using a cryptographic key K_{S}. For example, if the requested data R of the data order 122 is financial transaction data, the seller device 112 can encrypt the seller's 104 financial transaction data obtained from a source of the data (e.g., the seller's 104 bank). As shown by sub-block 326, this cryptographic key K_{S} can be generated as a random cryptographic key K_{S} by the client app 108 of the seller device 112.

At 328, the seller device 112 may determine a public address of the data buyer 102 based at least in part on the selected data order 122. For example, the public address of the data buyer 102 may be specified in the data order 122 and accessible to the seller device 112 when the seller 104 selects the data order 122.

At 330, the seller device 112 may determine a public address of a selected notary 106. For example, the data seller 104 may navigate to the public address of the data buyer 102 (as determined from the selected data order 122) to view a list of notaries 106 that are authorized for the selected data order 122, and the seller 104 may select one of those notaries 106, at which point the a public address of the selected notary 106 is determined by the seller device 112.

At 332, the seller device 112 may send a message to the public address of the notary 106, the message including, for instance, an identifier of the seller 104 (e.g., S_{ID}, Sₑₜₕ), the encrypted data 124 of the seller 104, and the cryptographic key K_{S} (which was used to encrypt the data 124). In some embodiments, the message sent at block 332 may further include an identifier of the selected data order 122 (Data Order ID: DO_{ID}). In some embodiments, sending the encrypted data 124 to the public address of the notary 106 at block 332 includes issuing a HTTPS POST request to the public address of the notary 106. As shown by off-page reference “B”, the operation(s) performed at block 332 may lead to operation(s) performed at block 340 (See FIG. 3C) where the notary device 114 accesses the public address of the notary 106 (e.g., to receive the encrypted data 124 provided to the notary 106 by the seller 104.

At 334, the seller device 112 may also send a message to the public address of the data buyer 102, the message including, for instance, an identifier of the seller 104 (e.g., S_{ID}, Sₑₜₕ) and the encrypted data 124 of the data seller 104: C_{S}=E_{K}_{_{S}}(Data_{S}). In some embodiments, the message sent at block 334 may further include, without limitation, (i) an identifier of the selected data order 122 (Data Order ID: DO_{ID}), (ii) a blockchain-based notary address (e.g., an Ethereum notary address Nₑₜₕ) of the selected notary 106 N∈L, (iii) a Boolean value (e.g., NeedsBuyerRegistration nbr: Boolean (for the Batch Payments 118(2) registration)), as described herein. In some embodiments, sending the encrypted data 124 to the public address of the buyer 102 at block 334 includes issuing a HTTPS POST request to the public address of the buyer 102. As shown by the off-page reference “C”, the operation(s) performed at block 334 may lead to operation(s) performed at block 304 where the buyer device 110 accesses the public address of the data buyer 102 (e.g., to browse interested sellers 104 and to receive encrypted data 124 of selected sellers 104).

At 336, the seller device 112 (or the delegate device 130) may execute instructions to call a method of the Batch Payments smart contract 118(2) to receive a batch of payments that includes a payment for the data 124 of the data seller 104. As shown by off-page reference “F”, the operation(s) performed at block 336 may result from operation(s) performed at block 358 (See FIG. 3C) where a master key M is revealed by the notary device 114 (or by the delegate device 130) via the Batch Payments smart contract 118(2). Thus, revelation of the master key by the notary 106 allows the seller 104 to get paid for the data 124 he/she sold to the buyer 102, and it allows the buyer 102 to gain access to the data 124 as well.

Turning to FIG. 3C, example operations performed by the notary device 114 (and possibly some operations performed by the delegate device 130) will now be described. At 338, and as a result of the data order 122 having been created at block 302 (as indicated by off-page reference “A”), the notary device 114 may receive an indication that a notary 106 associated therewith has agreed to validate requested data for the data order 122 created at block 302.

At 340, the notary device 114 may access a public address of the notary 106. As shown by off-page reference “B”, the operation(s) performed at block 340 may result from operation(s) performed at block 332 (See FIG. 3B) where the seller device 112 sends a message to the public address of the notary 106, the message including, for instance, the identifier of the seller 104, the encrypted data 124 of a seller 104, and the cryptographic key used to encrypt that data 124.

At 342, the notary device 114 may receive, via the public address of the notary 106, the encrypted data 124 of the data seller 104 and the cryptographic key that were provided by the data seller 104 at block 332 (See FIG. 3B). For example, receiving the encrypted data 124 of the data seller 104 at block 342 may comprises issuing a HTTPS GET request to the public address (e.g., public URL, public IP address, etc.) of the notary 106.

At 344, the notary device 114 may receive, via the public address of the notary 106, a first hash value and an identifier of the data seller 104 that was selected by a data buyer 102, and who provided encrypted data 124 to the public address of the notary 106. As shown by off-page reference “D”, the operation(s) performed at block 344 may result from operation(s) performed at block 310 (See FIG. 3A) where the buyer device 110 sends the message to the public address of the notary 106, the message including the first hash value(s) and a seller ID(s).

At 346, the notary device 114 may determine that a second hash value generated by the notary device 114 based at least in part on the encrypted data 124 of the data seller 104 (received at block 342) matches the first hash value received at block 344. This allows the notary 106 to verify that it has the same seller data 124 as the buyer 102 has in his/her possession.

At 348, the notary device 114 may decrypt and validate the seller data 124 received at block 342. For example, the notary device 114 can (via the client app 108) decrypt the encrypted data 124 C_{S}=(Data_{S}) received at block 342 using the cryptographic key K_{S} received at block 342 to obtain data of the data 124 seller 104. Thereafter, the notary device 114 can (via the client app 108) compare the data 124 (unencrypted) of the data seller 104 with previously-collected data 126 of the data seller 104 that is maintained in a database accessible to the notary 106 (e.g., ground truth data) to generate a notarization result, which indicates whether the data 124 of the data seller 104 is valid (approved) or invalid (rejected).

At 350, the notary device 114 can (via the client app 108) encrypt the cryptographic key K_{S} of the data seller 104 using a master key M to obtain an encrypted cryptographic key ck_{S}=E_{M}(K_{S}). As shown by sub-block 352, the notary device 114 can generate the master key M as a random master key using the client app 108 executing thereon.

At 354, the notary device 114 may generate a lock (e.g., Lock=H(N_{ID}∥M) based on the notary ID and the master key M. This lock is to be used by the buyer 102 with the Batch Payments smart contract 118(2) when it is sent to the buyer's 102 public address.

At 356, the notary device 114 may send a message to the public address of the data buyer 102, the message including, for instance, an identifier of the data seller 104 whose data was validated, the encrypted cryptographic key, notarization results (e.g., an indication that the data 124 of the data seller 104 was validated by the notary 106), and the lock Lock=H(N_{ID}∥M). In some embodiments, the message sent at block 356 may further include (i) an identifier of the selected data order 122 (Data Order ID: DO_{ID}), (ii) a notarization fee for the service performed, (iii) a notarization percentage applied (e.g., a percentage of sellers to be notarized that were actually audited)—the notary 106 can decide which data sellers 104 are notarized, (iv) a blockchain-based notary address (e.g., an Ethereum notary address Nₑₜₕ), (v) a hash of the pay data payDataHash to be sent to the Batch Payments smart contract 118(2) (e.g., a list of seller IDs written in an efficient way). As shown by off-page reference “E”, the operation(s) performed at block 356 may lead to operation(s) performed at block 312 where the buyer device 110 receives the seller ID(s), encrypted key, notarization results, and lock from the notary 106.

At 358, the notary device 114 (or the delegate device 130) may reveal the master key M with an on-chain operation. For example, the notary device 114/delegate device 130 may execute instructions to call a method of the Batch Payments smart contract 118(2) to reveal the master key M. For example, the notary device 114 may, at block 358, execute instructions (via the client app 108) to call an UnlockPayment method of the Batch Payments smart contract 118(2). The method of Batch Payments 118(2) called by the notary device 114 at block 358 may include, without limitation, the following parameters: (i) a Batch ID, (ii) the master key M. This revelation of the master key M at block 358 triggers the Batch Payments smart contract 118(2) to transfer payments of tokens from the buyer's 102 account into the respective accounts of the data seller(s) 104 and the notary 106. In addition, the buyer device 110 can verify the published master key M by checking that H(N_{ID}∥M)=Lock, use the master key M to decrypt the encrypted key ck_{S}=E_{M}(K_{S}) (i.e., compute K_{S}=D_{M}(C_{K}_{_{S}})) to obtain the cryptographic key K_{S} of the seller 104 (see block 316 of FIG. 3A), and use the cryptographic key K_{S} to decrypt the encrypted data 124 (i.e., compute Data=D_{K}_{_{S}}(C_{S})) of the seller 104 to obtain the data 124 of the seller 104 (see block 318 of FIG. 3A). In other words, the revelation of the master key M allows the buyer 102 to gain access to the seller's 104 data 124, in unencrypted form. The use of the master key M to unlock payments and to provide the buyer 102 with access to the seller's 104 data 124 is an example of an atomic data exchange mechanism, whereby real-world private information is exchanged using cryptographic protocols and a public blockchain to guarantee the fairness of transactions for data. “Atomicity”, in this context, means that, once data 124 is revealed to the data buyer 102, the data seller(s) 104 receives a payment for the data 124, and the notary 106 receives a payment for validating the data 124—none of the events occur independently without the others also occurring. Accordingly, as shown by off-page reference “F”, the operation(s) performed at block 358 may lead to operation(s) performed at block 316 (See FIG. 3A) where the buyer device 110 uses the master key M to gain access to the seller's 104 data 124, and may lead to operation(s) performed at blocks 336 (See FIG. 3B) and block 360 (See FIG. 3C) where the seller 104 and the notary 106 receive a batch of payments. For example, if the total value associated with a batch of payments in the notary's 106 account satisfies (e.g., meets, meets or exceeds) a threshold value, the notary device 114 (or the delegate device 130), at block 360, may execute instructions to call a method of the Batch Payments smart contract 118(2) to receive the batch of payments, which includes a payment for validating the data 124 of the data seller(s) 104. Likewise, at block 336 of FIG. 3B, if the total value associated with a batch of payments in the seller's 104 account satisfies (e.g., meets, meets or exceeds) a threshold value, the seller device 112, at block 336, may execute instructions to call a method of the Batch Payments smart contract 118(2) to receive the batch of payments, which includes a payment for selling the data 124 to the data buyer 102.

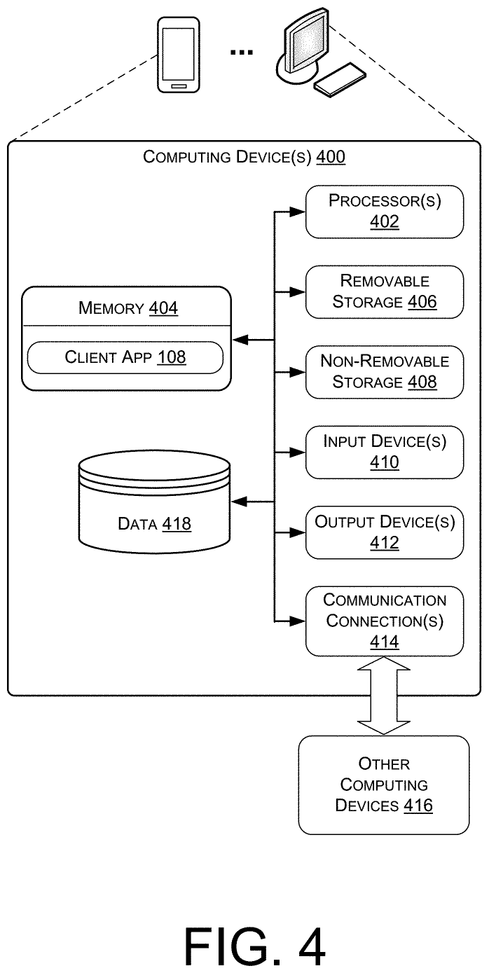

FIG. 4 is a block diagram of an example architecture of a computing device(s) 400 configured to implement the techniques described herein. For example, the computing device(s) 400 may represent the buyer device 110, the seller device 112, the notary device 114, or the delegate device 130 described herein. As shown, the computing device(s) 400 may include one or more processors 402 and one or more forms of computer-readable memory 404. The computing device(s) 400 may also include additional storage devices. Such additional storage may include removable storage 406 and/or non-removable storage 408.

In various embodiments, the computer-readable memory 404 generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 404 may also be described as computer storage media and may include volatile and nonvolatile, removable and non-removable media implemented in any method or technology for storage of information, such as computer readable instructions, data structures, program modules, or other data. Computer-readable memory 404, as well as the removable storage 406 and non-removable storage 408, are all examples of computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the computing device(s) 400. Any such computer-readable storage media may be part of the computing device(s) 400.

The computing device(s) 400 may further include input devices 410, including, without limitation, a touch screen (e.g., touch, or proximity-based) display, physical buttons (e.g., keyboard or keypad), a microphone, pointing devices (e.g., mouse, pen, stylus, etc.), or any other suitable input devices 410 coupled communicatively to the processor(s) 402 and the computer-readable memory 404. The computing device(s) 400 may further include output devices 412, including, without limitation, a display, one or more LED indicators, speakers, a printer, or any other suitable output device coupled communicatively to the processor(s) 402 and the computer-readable memory 404.

The computing device(s) 400 may further include communications connection(s) 414 that allow the computing device(s) 400 to communicate with other computing devices 416 such as via a network(s). The communications connection(s) 414 may facilitate transmitting and receiving wireless and/or wired signals over any suitable communications/data technology, standard, or protocol, as described above, such as using a packet data network protocol.

In some embodiments, the computer-readable memory 404 may include various modules, programs, objects, components, data structures, routines, and the like that perform particular functions according to various embodiments. In some embodiments, the computer-readable memory 404 includes the client app 108, described elsewhere herein, which may be a downloadable app or a cloud-based app that includes computer-executable instructions to perform particular functions according to various embodiments described herein. The computing device(s) 400 may further store data 418, such as the data 124 and 126 described herein, which may be maintained in any suitable data structure, such as a database or any similar data repository, store, or the like, which may be accessed by the one or more processors 402.

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

We claim:

1. A computer-implemented method comprising:
causing, by a computing device, a set of data orders for requested data to be displayed on the computing device, the set of data orders having been created by a corresponding set of data buyers using a first blockchain-based smart contract;
receiving an indication of a selected data order of the set of data orders;
encrypting data of a data seller associated with the computing device using a cryptographic key to obtain encrypted data;
determining a public address of a data buyer based at least in part on the selected data order;
sending, by the computing device, the encrypted data to the public address of the data buyer; and
sending, by the computing device, the encrypted data and the cryptographic key to a public address of a notary; and
executing, by the computing device, instructions to call a method of a second blockchain-based smart contract to receive, by the computing device, a batch of payments that includes a payment for the data of the data seller.

2. The computer-implemented method of claim 1, further comprising executing, by the computing device, instructions to call a method of a second blockchain-based smart contract to receive a batch of payments that includes a payment for the data of the data seller.

3. The computer-implemented method of claim 1, wherein:
the data of the data seller comprises at least one of:
financial transaction data associated with the data seller;
social network data of the data seller;
browsing history data of the data seller;
geolocation data of the data seller;
mobile phone data of the data seller;
biometric data of the data seller;
genetic data of the data seller;
device information of the data seller;
fitness application data of the data seller;
financial and lifestyle application data of the data seller; or
other wireless device or desktop application data of the data seller; and
the notary comprises at least one of:
a bank or financial company;
a social network service provider;
a mobile application vendor;
a telecommunications company;
an Internet service provider;
a healthcare company;
an e-commerce company; or
an online or brick-and-mortar retailer.

4. The computer-implemented method of claim 1, further comprising, prior to the encrypting the data, generating the cryptographic key as a random cryptographic key.

5. The computer-implemented method of claim 1, wherein the encrypted data is sent to the public address of the data buyer in a message that further includes at least one of:
an identifier of the selected data order;
an identifier of the data seller that is associated with the second blockchain-based smart contract;
an Ethereum address of the data seller;
an Ethereum address of the notary; or
a Boolean value indicating whether the data seller is to be automatically registered with the second blockchain-based smart contract.

6. The computer-implemented method of claim 1, wherein:
individual data orders of the set of data orders are displayed along with:
a price offered by an individual data buyer for the requested data; and
terms and conditions of how the requested data can be used by the individual data buyer after the individual data buyer receives the requested data; and
a set of notaries is accessible via the public address of the data buyer, the set of notaries including the notary.

7. A system comprising:
one or more processors; and
memory communicatively coupled to the one or more processors and storing computer-executable instructions that, when executed by the one or more processors, cause the system to perform the method of claim 1.

8. A computer-implemented method comprising:
executing, by a computing device, first instructions to call a first method of a first blockchain-based smart contract to create a data order for requested data;
accessing, by the computing device, a public address of a data buyer associated with the data order, wherein the accessing of the public address causes an identifier of a data seller who has selected the data order to be presented for selection on a display of the computing device;
receiving an indication that the identifier of the data seller has been selected by the data buyer;
receiving, by the computing device, via the public address of the data buyer, encrypted data of the data seller;
sending, by the computing device, the identifier of the data seller and a hash of the encrypted data of the data seller to a public address of a notary;
receiving, by the computing device, via the public address of the buyer, an encrypted cryptographic key and an indication that the encrypted data of the data seller was validated by the notary;
executing, by the computing device, second instructions to call a second method of a second blockchain-based smart contract, the second method specifying the identifier of the data seller and an identifier of the notary to authorize respective payments to be made to respective accounts of the data seller and the notary;
decrypting the encrypted cryptographic key using a master key that was revealed via the second blockchain-based smart contract to obtain a cryptographic key; and
decrypting the encrypted data of the data seller using the cryptographic key to obtain data of the data seller.

9. The computer-implemented method of claim 8, wherein the accessing of the public address of the data buyer further causes presentation on the display of the computing device of at least one of:
an identifier of the data order;
an Ethereum address of the notary; or
a Boolean value indicating whether the data seller is to be automatically registered with the second blockchain-based smart contract.

10. The computer-implemented method of claim 8, wherein:
the data order includes at least one of:
an identifier of the data order;
a price offered by the data buyer for the requested data; or
terms and conditions of how the requested data can be used by the data buyer after the data buyer receives the requested data; and
a set of notaries usable to validate the requested data is provided via the public address of the data buyer, the set of notaries including the notary.

11. The computer-implemented method of claim 8, wherein the public address of the data buyer is a public Uniform Resource Locator (URL) of the data buyer, and wherein the receiving, by the computing device, via the public address of the data buyer, the encrypted data of the data seller comprises issuing a Hypertext Transfer Protocol Secure (HTTPS) GET request to receive the encrypted data of the data seller.

12. The computer-implemented method of claim 8, further comprising receiving, by the computing device, a lock generated by a second computing device of the notary, wherein the second method further specifies the lock.

13. The computer-implemented method of claim 8, further comprising:
registering the data buyer with the second blockchain-based smart contract; and
adding tokens of the data buyer that are usable to make the respective payments to the respective accounts of the data seller and the notary.

14. A system comprising:
one or more processors; and
memory communicatively coupled to the one or more processors and storing computer-executable instructions that, when executed by the one or more processors, cause the system to perform the method of claim 8.

15. A computer-implemented method comprising:
receiving, by a computing device, an indication that a notary has agreed to validate requested data for a data order, the data order having been created by a data buyer using a first blockchain-based smart contract;
receiving, by the computing device, via a public address of the notary, encrypted data of a data seller and a cryptographic key;
receiving, by the computing device, via the public address of the notary, a first hash value and an identifier of the data seller that was selected by the data buyer;
determining that a second hash value generated based at least in part on the encrypted data of the data seller matches the first hash value;
decrypting the encrypted data using the cryptographic key to obtain data of the data seller;
comparing the data of the data seller with previously-collected data of the data seller that is maintained in a database accessible to the notary to generate a notarization result indicating that the data of the data seller is valid;
encrypting the cryptographic key using a master key to obtain an encrypted cryptographic key;
sending, by the computing device, the encrypted cryptographic key and an indication that the data of the data seller was validated by the notary to a public address of the data buyer; and
executing, by the computing device, instructions to call a method of a second blockchain-based smart contract to reveal the master key.

16. The computer-implemented method of claim 15, wherein:
the data of the data seller is anonymized and comprises at least one of:
financial transaction data associated with the data seller;
social network data of the data seller;
browsing history data of the data seller;
geolocation data of the data seller;
mobile phone data of the data seller;
biometric data of the data seller;
genetic data of the data seller;
device information of the data seller;
fitness application data of the data seller;
financial and lifestyle application data of the data seller; or
other wireless device or desktop application data of the data seller; and
the notary comprises at least one of:
a bank or financial company;
a social network service provider;
a mobile application vendor;
a telecommunications company;
an Internet service provider;
a healthcare company;
an e-commerce company; or
an online or brick-and-mortar retailer.

17. The computer-implemented method of claim 15, further comprising, prior to the encrypting the cryptographic key, generating the master key as a random master key.

18. The computer-implemented method of claim 15, further comprising:
generating a lock; and
sending, by the computing device, the lock to the public address of the data buyer.

19. The computer-implemented method of claim 15, further comprising, after executing the instructions:
executing, by the computing device, second instructions to call a second method of the second blockchain-based smart contract to receive a batch of payments that includes a payment for validating the data of the data seller.

20. A system comprising:
one or more processors; and
memory communicatively coupled to the one or more processors and storing computer-executable instructions that, when executed by the one or more processors, cause the system to perform the method of claim 15.
